(19) United States
(12) Patent Application Publication
(10) Pub. No.: US 2013/0252479 A1
(43) Pub. Date: Sep. 26, 2013

(54) TERMINAL BLOCK HOLDER

(71) Applicants: Cary Ramey, Greenwood, IN (US); Colin Hamer, Noblesville, IN (US); Jim Ramey, Fortville, IN (US)

(72) Inventors: Cary Ramey, Greenwood, IN (US); Colin Hamer, Noblesville, IN (US); Jim Ramey, Fortville, IN (US)

(21) Appl. No.: 13/425,109

(22) Filed: Mar. 20, 2012

(51) Int. Cl. H01R 9/24; H01R 43/16

(52) U.S. Cl. 439/709; 29/874

(57) ABSTRACT

A terminal block holder is provided for securing a terminal block assembly having at least three conductive bus bars enclosed within corresponding individual insulating columns passing through a housing of an electric machine, the terminal block holder including a plate defining at least three openings therein, and including first and second dividers extending from the plate and respectively separating different adjacent ones of the openings, where the plate is adapted to abut the terminal block assembly in a first direction, where the plate is adapted to abut the housing in a second direction, where the dividers are adapted to abut the terminal block assembly in a third direction, and where the first, second and third directions are substantially perpendicular to one another.

### BACKGROUND

The present invention relates generally to structural integrity of electrical connection portions of electric machines and, more particularly, to apparatus and methods for securely holding a terminal block of an electric machine in place.

The stator assembly of an electric machine may be formed by installation of coils of conductor wire into a stator core. For example, the stator assembly of a vehicular electric or hybrid motor and/or generator may be manufactured by populating the stator core with individual hairpin conductor segments in a distributed arrangement, by concentrated windings, by use of permanent magnets, or by other appropriate structure. The ends of the assembled coils may be extended from the stator and terminated at a terminal block for subsequent connection to an electrical power system, for example an inverter of an electric vehicle.

Conventional electric machines may include a terminal block attached to a housing, or attached to an ancillary structure such as an intermediate assembly within such housing, by using fasteners. However, in many applications, the electric machine is subjected to prolonged vibration that can cause the terminal block to become dislodged when such fasteners become weak or loose. When using fasteners, there is a need to stock and install small parts and to provide fastening portions in the housing. Such fastening parts may be accidently dropped into the electric machine during assembly. Bolts and nuts may require that their own insulating material and access space be provided.

In many applications, foreign objects may come into contact with a terminal block portion and move the terminal block from its nominal position. Vibration may be transmitted to the terminal block through power cables connected thereto. In addition to vibration, the terminal block portion may be subjected to servicing and repair operations that may move and/or damage it. Dirt and debris may become lodged in the terminal block area over time and may act to wedge the terminal block away from a seated position. Heat and other environmental conditions may act to degrade terminal block materials and seals, such as by altering their shape. Any combination of these factors may occur and may have a cumulative effect, whereby a terminal block may become dislodged from the electric machine.

### SUMMARY

It is therefore desirable to obviate the above-mentioned disadvantages by providing a terminal block holder for preventing terminal blocks in an electric machine from becoming dislodged as a result of internal and/or external forces being exerted on the machine. Reducing the movement of a terminal block in a given electric machine reduces associated failures and thereby increases the life of the electric machine. Embodiments of a terminal block holder may be fabricated by a simple operation. The terminal block holder may be utilized for locking and retaining one or more terminal blocks by preventing movement in each of the x, y, and z axes, for electrically insulating the terminals from one another and from contact with surrounding metal surfaces, such as the interior surfaces of the electric machine, and for maintaining a sealing structure for preventing unwanted dirt and debris from entering the electric machine and associated electrical power connections. The terminal block holder may also be optimized for use in an air-cooled electric machine, an oil-cooled electric machine, and a water-cooled electric machine. It is also advantageous to provide a method and structure for securing a terminal block by a modular system that may be easily adapted for electric machines of various sizes and shapes. It is also advantageous to provide a method and structure that improves reliability and integrity of electrical power connections of an electrical machine subjected to high levels of vibration and other environmental stress. The particular configuration and placement of the apparatus within an electric machine assures that three-dimensional structural engagement of the apparatus secures the terminal block(s) in place without a need for additional features or fasteners.

In one embodiment, a terminal block holder is provided for securing a terminal block assembly having at least three conductive bus bars enclosed within corresponding individual insulating columns passing through a housing of an electric machine, the terminal block holder including a plate defining at least three openings therein, and including first and second dividers extending from the plate and respectively separating different adjacent ones of the openings, where the plate is adapted to abut the terminal block assembly in a first direction, where the plate is adapted to abut the housing in a second direction, where the dividers are adapted to abut the terminal block assembly in a third direction, and where the first, second and third directions are substantially perpendicular to one another.

In another embodiment, an electrical termination system includes a housing of an electric machine having a plurality of individual passages connecting interior and exterior sides thereof, a terminal block assembly having at least three conductive bus bars enclosed within corresponding individual insulating bodies passing through corresponding ones of the individual passages of the housing, and a terminal block holder for securing the terminal block assembly, the terminal block holder including a plate defining at least three openings therein, each opening being aligned with a respective one of the bus bars, and including first and second dividers extending from the plate and respectively separating different adjacent ones of the openings. The plate abuts the terminal block assembly in a first direction, the plate abuts the terminal block assembly or the housing in a second direction, the dividers abut the terminal block assembly in a third direction, and the first, second and third directions are substantially perpendicular to one another.

In yet another embodiment, a method of securing a terminal block within a housing of an electric machine includes placing the terminal block assembly into abutment with the housing so that the terminal block assembly is positioned in close proximity to an exterior of the housing and extends through a plurality of individual passages to an interior of the housing, and placing a terminal block holder into abutment with the terminal block assembly within the housing interior, so that the terminal block holder abuts the terminal block assembly in a first direction, abuts one of the terminal block assembly and the housing in a second direction, and abuts the terminal block assembly in a third direction, where the first, second and third directions are substantially perpendicular to one another.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein

FIG. 1 is a partial perspective view of a housing of an electric machine, showing ports used for electrical power connections to the machine;

FIG. 2 is a partial perspective view showing terminal blocks, a cable entry box, an end plate, and other structure added to the housing of an electric machine of FIG. 1;

FIG. 3 is a partial perspective view of an electrical power connection portion in the interior of an electric machine;

FIG. 4A and FIG. 4B are respective front and rear perspective views of a terminal block holder according to an exemplary embodiment;

FIG. 5 is a partial perspective view of the terminal block holder of FIGS. 4A-4B installed at an electrical power connection portion in the interior of an electric machine, according to an exemplary embodiment;

FIG. 6 is a cross-sectional view of an electrical power connection portion of an electric machine including the terminal block holder of FIGS. 4A-4B, according to an exemplary embodiment;

FIG. 7 is another cross-sectional view of an electrical power connection portion of an electric machine including the terminal block holder of FIGS. 4A-4B, according to an exemplary embodiment;

FIG. 8 is a further cross-sectional view of an electrical power connection portion of an electric machine including the terminal block holder of FIGS. 4A-4B, according to an exemplary embodiment; and

FIG. 9A and FIG. 9B are respective top and bottom perspective views of a terminal block holder according to an exemplary embodiment.

Corresponding reference characters indicate corresponding parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

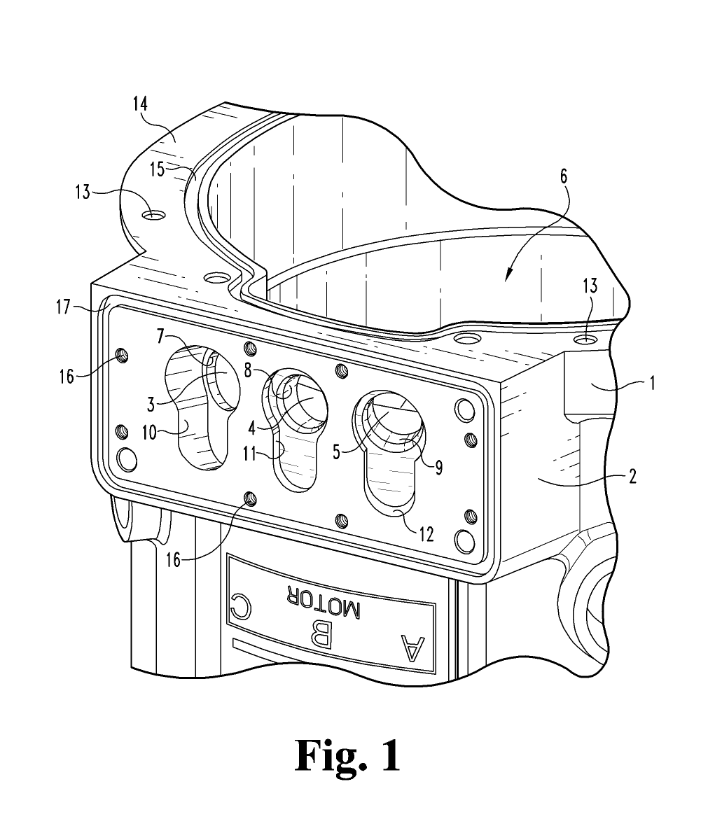

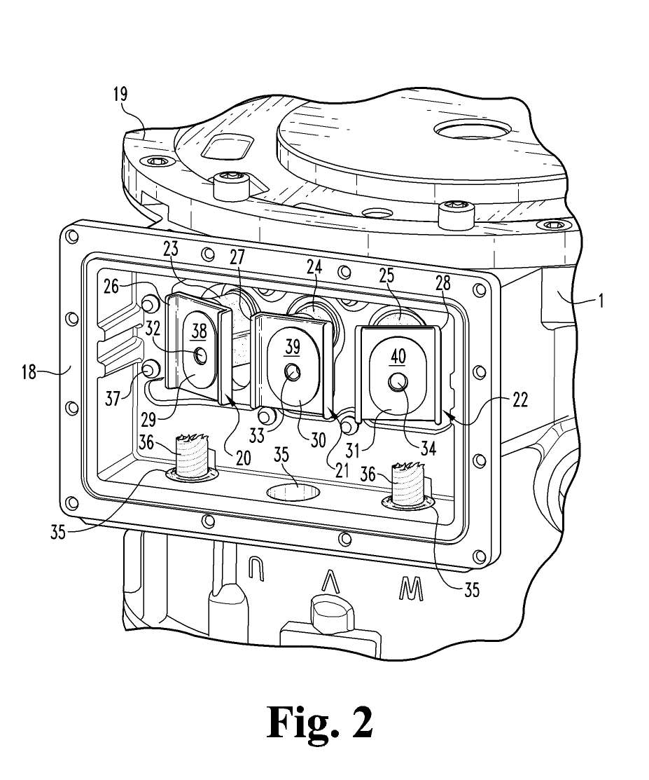

FIG. 1 is a partial perspective view of an exemplary electric machine housing 1, typically formed of aluminum, magnesium, steel, iron, and/or other suitable metal. Housing 1 may include various interior and exterior surfaces configured for supporting and/or protecting various components. For example, an electric power transfer portion 2 of housing 1 has three terminal ports 3, 4, 5 that are holes leading to the housing interior 6. The respective holes are defined by circular openings in respective wall portions 7, 8, 9 and by enlarged keyed receptacles formed in respective wall portions 10, 11, 12. Terminal ports 3 and 5 have respective center axes that are skewed with respect to that of terminal port 4, so that such center axes diverge from terminal port 4 in the outward direction. A number of threaded holes 13 and an O-ring groove 15 are formed along a flat end surface 14 for subsequent installation of an end plate 19, shown by example in FIG. 2. A number of threaded holes 16 and an O-ring groove 17 are formed in power transfer portion 2, for installation of a cable entry box 18, also shown by example in FIG. 2.

FIG. 2 is a partial perspective view of an electric machine housing 1 having three terminal blocks 20, 21, 22 inserted into respective terminal ports 3, 4, 5. Each terminal block 20, 21, 22 respectively has an insulating body 23, 24, 25 typically a high temperature insulating material integrally formed with and extending from a respective high voltage termination plate 26, 27, 28 at an end portion thereof. Each insulating body 23, 24, 25 encloses a respective metal conductor bar 29, 30, 31 having a respective threaded receptacle 32, 33, 34 for securing a high voltage cable terminal (not shown) thereto. Each respective high voltage termination plate 26, 27, 28 has parallel outer walls for securing the terminal in the proper orientation. Cable entry holes 35 are provided in cable entry box 18 for installing cables 36. The terminals of the installed cables 36 are flush mounted onto respective flat conductor surfaces 38, 39, 40 of conductor bars 29, 30, 31, such surfaces being substantially perpendicular to respective threaded receptacles 32, 33, 34 and substantially perpendicular to the respective center axes of terminal ports 3, 4, 5. Grommets, sealant, strain relief devices, or the like (not shown) may be used for sealing holes 35 after cable installation. Cable entry box 18 is secured to housing 1 using threaded fasteners 37.

In a typical application, for example a hybrid or all-electric vehicle propulsion motor, electric power is provided by a battery bank and an inverter (not shown) to an electric machine operating as a motor. Electric power may be supplied from the electric machine when it operates as a generator, such as during engine braking. Connection cables 36 are typically 2/0 AWG or a larger size for carrying high voltage and high current. The voltage being supplied from an inverter may be 500 AC volts or more, for example as U, V and W-phase electric power. It is necessary to maximize the stability of high voltage electrical connection portions, thereby reducing electrical and mechanical noise, preventing short-circuiting, and reducing mechanical failures and weakening of the structure that may occur due to vibration from the electric machine, the cables, and from other vehicle sources, such as vibration that occurs while a vehicle is traveling on bumpy roads. Cables 36 are typically provided with a thick, durable, water-proof insulation, and the cable layout and tie-down fixation are chosen to minimize transfer and propagation of vibration. Although conventional cable fixation structure such as strain relief and cable stays may be utilized for damping the vibration and for supporting the electrical connections, it does not support terminal blocks. In some cases, cable fixation may cause tensioning on the high voltage cables and on associated connections, which may weaken the terminal blocks and weaken the attachment of the terminal blocks to a housing or other support structure. For example, an attached cable 36 may transfer a force to a terminal block that acts in one direction while the terminal block is being bounced in a different direction by a force directed to a housing on which the terminal block is mounted.

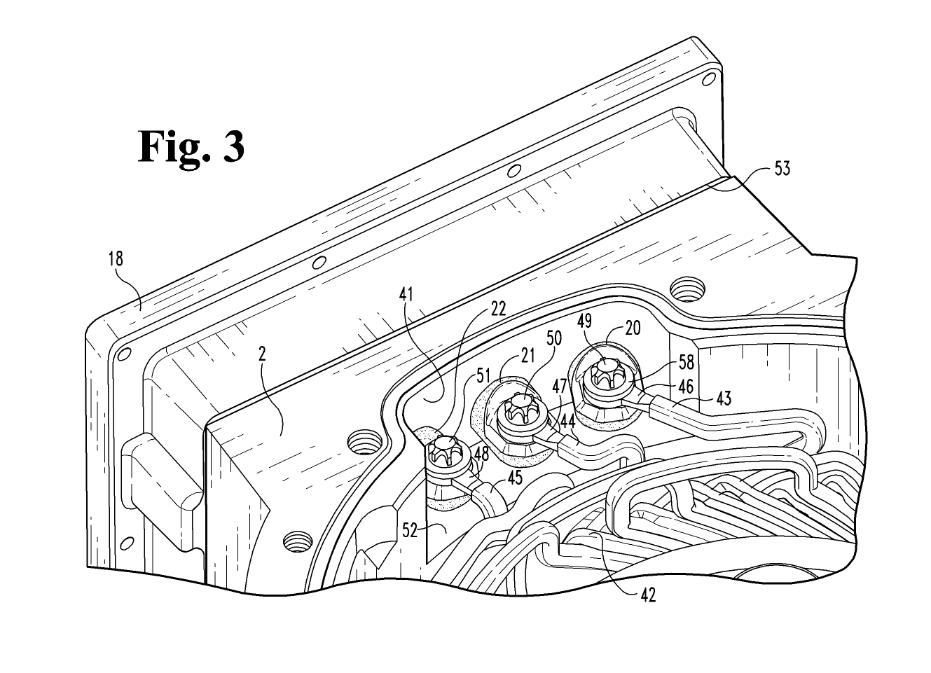

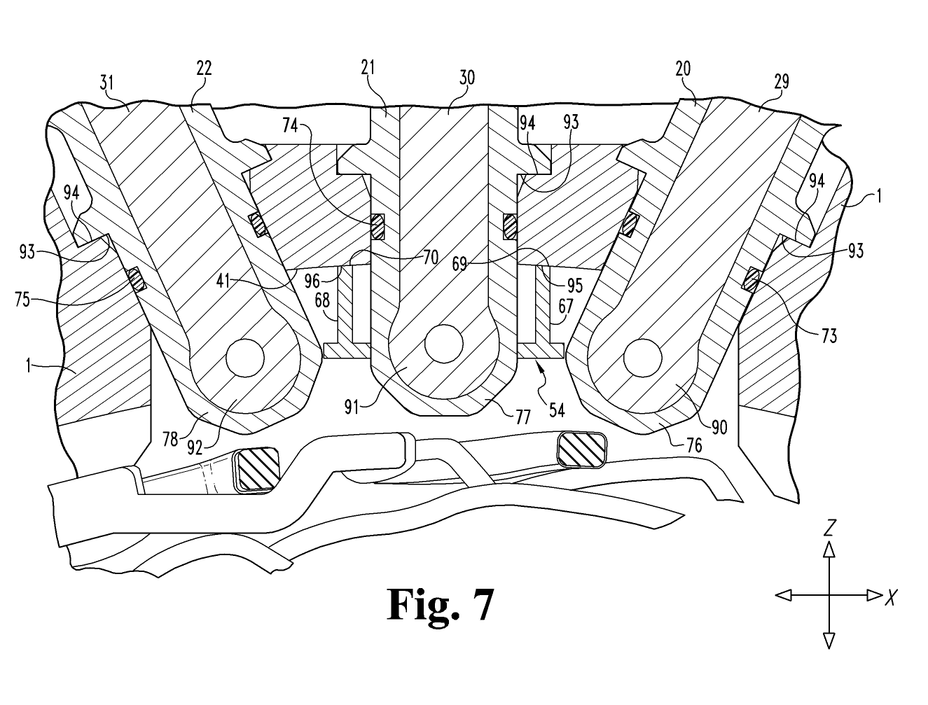

FIG. 3 is a partial perspective view of the terminal block portion in interior 6 (e.g., FIG. 1) of an electric machine. The exemplary electric machine has stator windings formed as series of conductor segments 42. The stator is thereby formed as at least three individual coils having respective coil ends 43, 44, 45, terminated at respective ring terminals 46, 47, 48. Installed terminal blocks 20, 21, 22 each have a generally round or oval profile extending out of interior wall 41, and have generally flat portions where corresponding flat portions 90, 91, 92 (as best shown in FIG. 7) of respective conductor bars 29, 30, 31 are exposed. The remaining portions of terminal blocks 20, 21, 22 surround metal of conductor bars 29, 30, 31 and associated fasteners, discussed below. Ring terminals 46, 47, 48 are respectively attached and secured to the flat exposed conductor portions 90, 91, 92 using bolts 49, 50, 51. An interior ledge wall 52, in combination with interior wall 41, forms a terminal connection space where high voltage connections are made, for example to allow an assembler to drive bolts 49, 50, 51 without accidentally damaging the various stator wires. A gasket 53 or similar seal is placed between electric power transfer portion 2 of housing 1 and cable entry box 18.

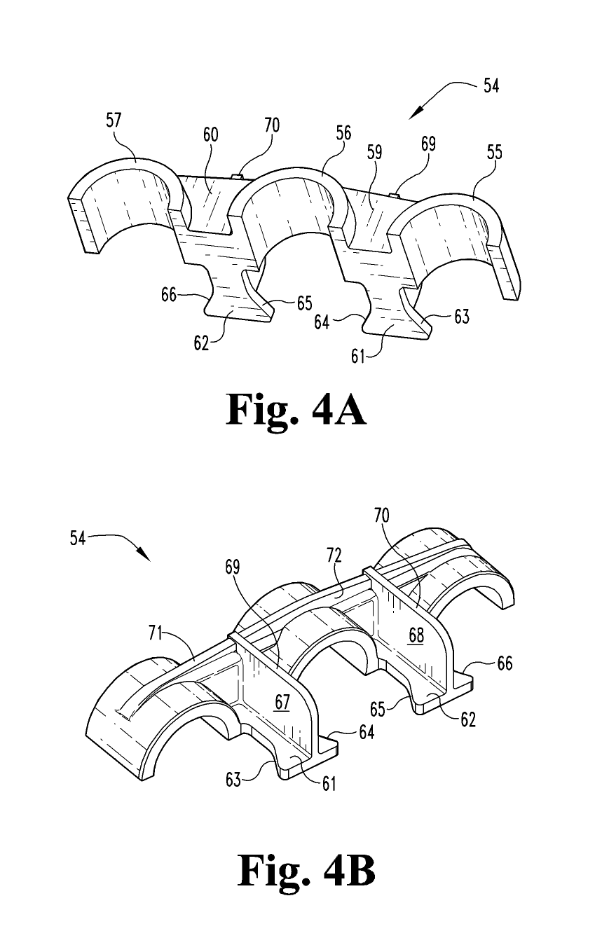

FIGS. 4A and 4B are respective front and rear perspective views of an embodiment of a terminal block holder 54 formed as a unitary structure, for example by injection molding a resin material. Terminal block holder 54 has three semi-circular columns 55, 56, 57 each having an inside diameter slightly larger than the size of the flange 58 of bolt 49. Columns 55, 56 are separated by a spacer portion 59, and columns 56, 57 are separated by a spacer portion 60. Spacer portions 59, 60 have respective bell-bottom lower portions 61, 62. Bell-bottom portion 61 has opposite-facing side wall portions 63, 64, and bell-bottom portion 62 has opposite-facing side wall portions 65, 66. A spine 67 extends perpendicularly from the rear side of spacer portion 61 to thereby form a “T” shape. A spine 68 extends perpendicularly from the rear side of spacer portion 62 to thereby form a “T” shape. The respective rear edges 69, 70 of spines 67, 68 are perpendicular to a rear rib portion 71 that extends laterally to connect spines 67, 68 and that extends to connect columns 55, 56, 57. Rib 71 has a bottom-facing surface 72. The substantially widthwise body of terminal block holder 54 that includes, for example, spacer portions 59, 60 and rib portion 71, may be generally referred to herein as a plate. Other configurations of a plate may be used for a particular terminal block holding application.

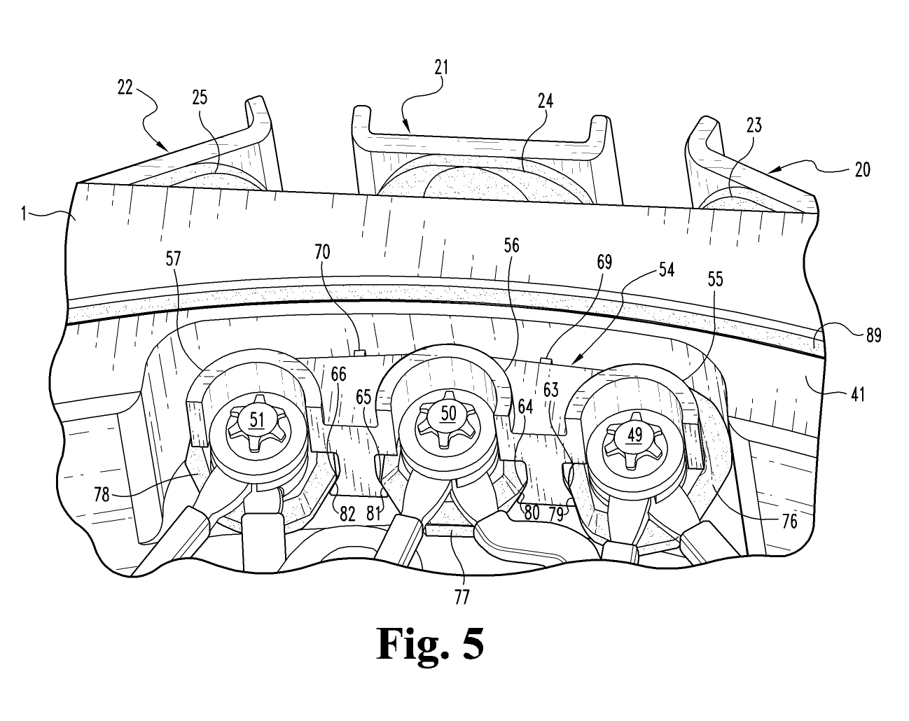

FIGS. 5-8 show terminal block holder 54 installed to secure terminal blocks 20, 21, 22 within housing 1. FIG. 5 is a partial perspective view of the terminal block portion of an electric machine, with cable entry box 18 removed for illustration purposes (c.f., FIG. 3). O-rings 73, 74, 75 (e.g., FIG. 7) are placed into grooves of respective insulating bodies 23, 24, 25 and then terminal blocks 20, 21, 22 are installed through housing 1 so that insulating end portions 76, 77, 78 of respective terminal blocks 20, 21, 22 extend from interior wall 41. Terminal block holder 54 is placed in snug abutment with interior wall 41 before, during, or after installation of terminal blocks 20, 21, 22, whereby side wall 63 abuts lateral surface 79 of end portion 76, side wall 64 abuts lateral surface 80 of end portion 77, side wall 65 abuts lateral surface 81 of end portion 77, and side wall 66 abuts lateral surface 82 of end portion 78. The diameter of the head of each respective bolt 49, 50, 51 is slightly less than the inside diameter of corresponding column 55, 56, 57.

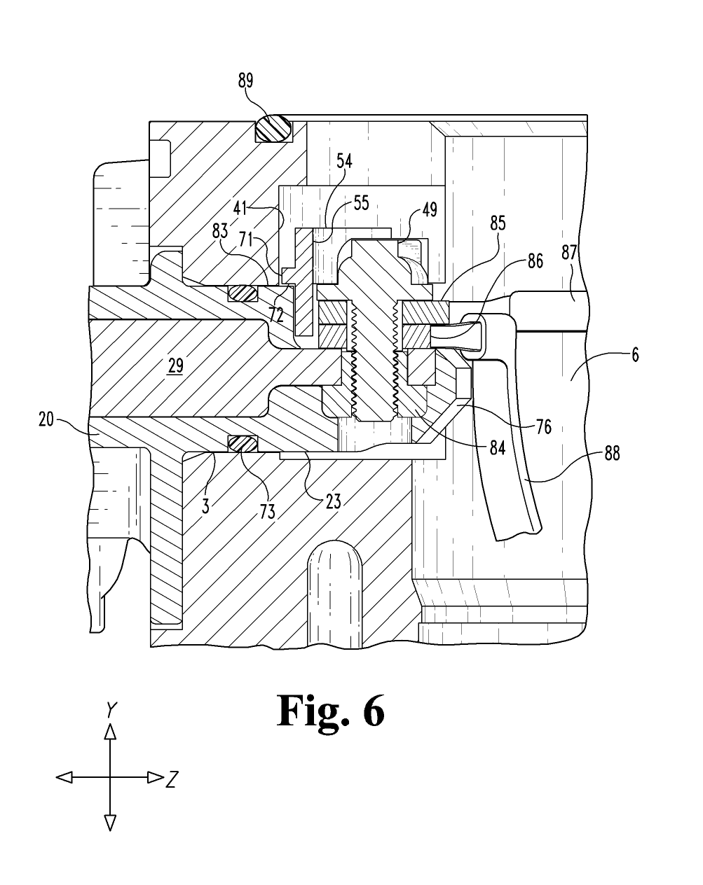

FIG. 6 is a representative cross-sectional side view. O-ring 73 maintains a seal that prevents contamination from entering interior 6 through terminal port 3. Surface 72 of rib 71 rests on a face 83 of insulating body 23. A nut 84 is provided within end portion 76 of terminal block 20, snugly fitted into an annular hole in conductor bar 29. Ring terminals 85, 86, connected to respective coil wires 87, 88 of the stator, are placed to have their center openings aligned with the annular hole of conductor bar 29, and then bolt 49 is inserted through ring terminals 85, 86 and through the annular conductor hole into nut 84. When bolts 50, 51 have been placed through annular holes in respective conductor bars (e.g., FIG. 2) and terminal block holder 54 has been properly installed and positioned, then bolts 49, 50, 51 are tightened into the respective nuts with specified torque. Column 55 has an inside diameter slightly greater than the diameter of bolt 49. The tightening urges surface 72 of rib 71 into snug abutment with face 83 of terminal block 20. When all terminal connections are made and all testing has been performed, an O-ring or gasket 89 is installed into a groove 15 (e.g., FIG. 1) and then an end plate 19 (e.g., FIG. 2) is secured to housing 1.

FIG. 7 is a cross-sectional top view showing O-rings 73, 74, 75 that seal respective terminal blocks 20, 21, 22 to housing 1. Conductor bars 29, 30, 31 have respective annular connection portions 90, 91, 92 formed in corresponding insulating end portions 76, 77, 78 of terminal blocks 20, 21, 22. Each terminal block 20, 21, 22 has one or more resting surface(s) 93 that abut a corresponding engagement surface 94 of housing 1. Gaskets (not shown) may be installed between resting surfaces 93 and engagement surfaces 94. Rear edge 69 of spine 67 of terminal block holder 54 abuts a contacting surface 95 of interior surface 41. Rear edge 70 of spine 68 of terminal block holder 54 abuts a contacting surface 96 of interior surface 41.

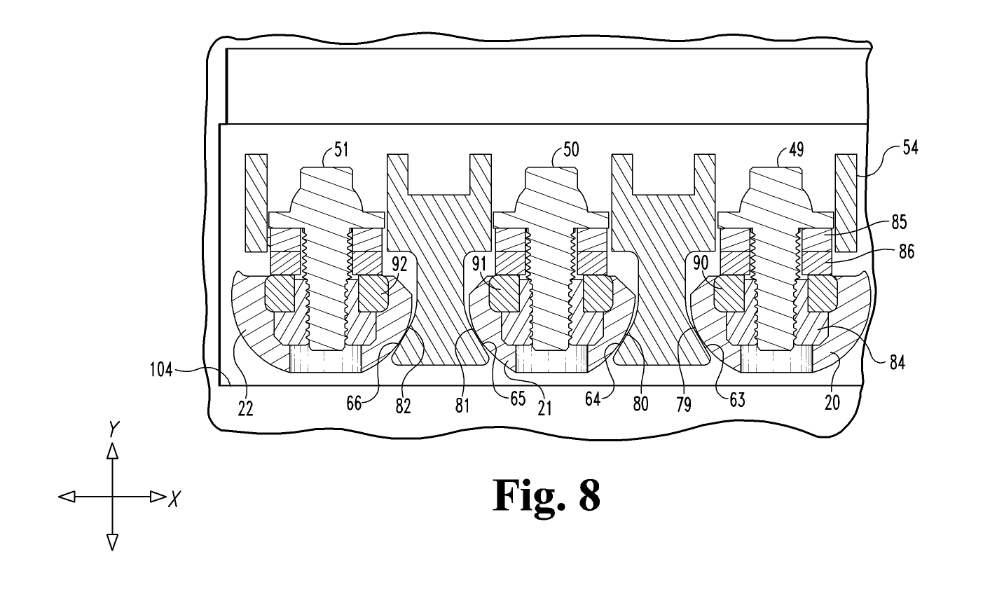

FIG. 8 is a cross-sectional front view of terminal block holder 54 installed in an electrical power connection portion of an electric machine. Bolt 49, ring terminals 85, 86, connection portion 90 of conductor bar 29, and nut 84 are in electrical communication with one another and are pressed together by bolt 49 being tightened into nut 84. Bolts 50, 51 are tightened in the same manner so that respective conductor connection portions 91, 92 are electrically connected to corresponding stator coil ends. Side wall 63 of terminal block holder 54 abuts lateral insulating surface 79 of terminal block 20, side wall 64 abuts lateral insulating surface 80 of terminal block 21, side wall 65 abuts lateral insulating surface 81 of terminal block 21, and side wall 66 abuts lateral insulating surface 82 of terminal block 22. A bottom shelf 104 is formed by recessing interior wall 41 in a direction of the exterior of housing 1.

Terminal block holder 54 thereby secures terminal blocks 20, 21, 22 in three mutually perpendicular axes. For example, the snug fit of terminal block insulating portions 23, 24, 25 with respective terminal ports 3, 4, 5 prevents movement in all directions. The abutment, for example, of edges 69, 70 with respective contacting surfaces 95, 96 of interior wall 41 (e.g., FIG. 7) secures terminal blocks 20, 21, 22 in the z-axis direction, especially when the heads of respective bolts 49, 50, 51 snugly fit inside corresponding columns 55, 56, 57 of terminal block holder 54. Typically, an epoxy compound may be placed into columns 55, 56, 57 after assembly and testing, thereby bonding the conductor bars, ring terminals, and bolts with terminal block holder 54, and further preventing any relative movement. The abutment of side walls 63, 64, 65, 66 with respective terminal block lateral surfaces 79, 80, 81, 82, the integral structure of terminal block holder 54, and the snug fit of terminal block insulating portions 23, 24, 25 with respective terminal ports 3, 4, 5 prevent movement in a x-direction. The abutment of holder surface 72 with terminal block face 83 (e.g., FIG. 6), and the bell-bottom shaped abutment of holder side walls 63, 64, 65, 66, with respective terminal block lateral surfaces 79, 80, 81, 82 secures terminal blocks 20, 21, 22 in the y-axis direction.

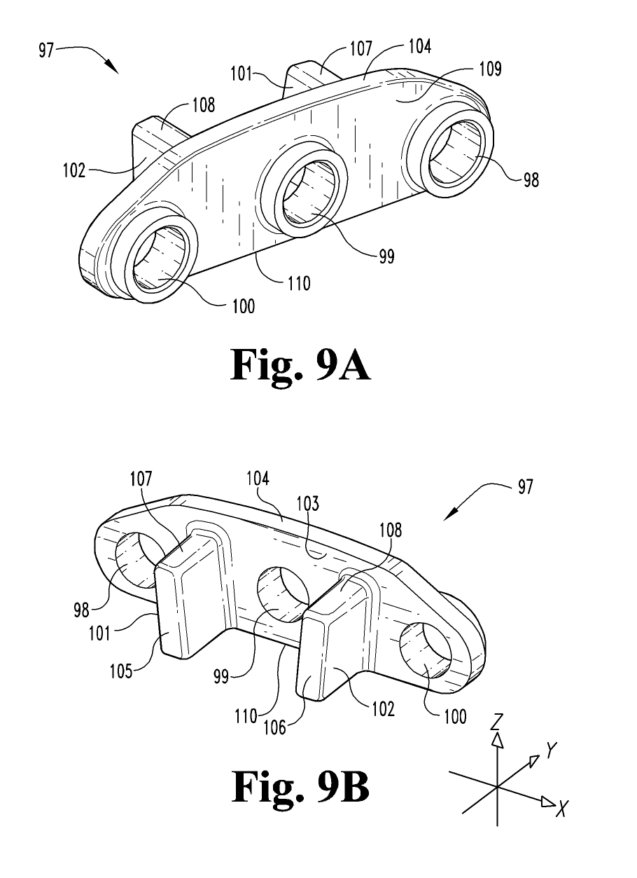

FIG. 9A and FIG. 9B are respective top and bottom perspective views of an embodiment of a terminal block holder 97 formed as a unitary structure, for example by injection molding a resin material. Terminal block holder 97 has three circular columns 98, 99, 100 each having an inside diameter larger than the size of the flange 58 of bolt 49 (e.g., FIG. 3) and an outer boss portion that extends above top surface 109. A first spacer 101 and a second spacer 102 each extend from the bottom surface 103. The widths of spacers 101, 102 are chosen to respectively match the distance between end portion 76 and end portion 77, and between end portion 77 and end portion 78, thereby preventing x-axis movement between terminal blocks 20, 21, 22 when terminal block holder 97 is installed. Abutment surface 104 is shaped to match the shape of interior wall 41, whereby abutment surface 104 is flush with interior wall 41 when terminal block holder 97 is installed, thereby preventing z-axis movement. Terminal block holder 97 may be formed so that bottom surfaces 105, 106 are placed in abutment with shelf 104 (e.g., FIG. 8), so that terminal block holder 97 may be consistently placed relative to a y-axis location. In particular, the distance from surfaces 105, 106 to abutment surface 104 may be chosen so that both abutment surface 104 and bottom surfaces 105, 106 are contacting housing 1 when terminal block holder 97 is installed. In addition, interior wall 41 may have a protruding portion that includes contacting surfaces 95, 96, whereby spacers 101, 102 may be configured so that back surfaces 107, 108 each contact such contacting surfaces 95, 96 when terminal block holder 97 is installed. In such a case, terminal block holder 97 may be installed by pressing down on top surface 109 and pushing radially outward on flat surface 110, whereby surfaces 105, 106 contact housing 1 in the y-axis direction, and abutment surface 104 and bottom surfaces 105, 106 contact housing 1 in the z-axis direction. Spacers 101, 102 may be formed to snugly fit respectively between lateral terminal block surfaces 79, 80 and between lateral terminal block surfaces 81, 82, thereby securing terminal blocks 20, 21, 22 in the x-direction (see, e.g., FIG. 8). In this example, terminal block holder 97 secures terminal blocks 20, 21, 22 in all three axes. Additional structural integrity and support may be provided by annular bores (not shown) formed on an internal surface of end plate 19 (e.g., FIG. 2), such bores aligning with and retaining the bushing portions of columns 98, 99, 100. For example, after assembly and testing of the electric machine, end plate 19 is placed on top of flat end surface 14 and aligned so that bushings 98, 99, 100 are inserted into the annular bores, thereby further restraining x-direction and y-direction movement of the terminal block portions. The substantially widthwise body of terminal block holder 97 that includes, for example, spacers 101, 102, may be generally referred to herein as a plate.

In an exemplary embodiment, the multiple-phase coils of a stator are installed in housing 1 and a number of terminal ports of housing 1 are filled by pressing a terminal block and associated O-ring into each port. A terminal block holder is placed into its nominal position along an inner surface of housing 1, whereby the terminal blocks are spaced apart from one another and supported against relative movement in the x-direction. The interior portions of the terminal blocks each have an exposed metal connection portion that is brought into electrical communication with end(s) of respective ones of the stator coils, according to the chosen wiring diagram. For example, a given stator may be structured as three-phase, six-phase, Wye, Delta, or other configuration including, but not limited to multiple taps of a coil, neutral connection(s), connection to external components, and others. The various electrical connections are made to corresponding ones of the exposed terminal block metal surfaces such as by use of ring terminals. The terminal block holder and individual terminal blocks are then seated in their nominal locations and the fasteners of the terminal blocks are tightened, thereby locking the terminal block holder and terminal blocks together so that they are secured within housing 1. The terminal block holder is not attached to housing 1, to any of the terminal blocks, or to any of the coil wires, whereby slight adjustments of relative positions during manufacturing allow for proper alignment of the various components. In various embodiments, the terminal block holder is installed prior to, during, or after the installation of individual terminals blocks.

Housing 1 may have external cooling fins and one or more associated cooling fans. With increased power and power/weight requirements for vehicular electric machines, and with the use of permanent magnets (not shown), fins and fans alone may be inadequate for discharging heat from an electric machine. For example, excessive heat can occur in the vicinity of the bearings, the sealing devices, the rotor, and the stator, causing component failure, degradation, reduced performance, and other undesirable results. Therefore, various embodiments may include a cooling system (not shown) using one or more fluids such as air, water, and coolant such as oil. For example, housing 1 may include a cooling jacket that may be in fluid communication with interior cavity 6, the stator core (not shown), and with end turns of conductor segments 42 (e.g., FIG. 3). The cooling system may also include cooling channels in a rotor (not shown) of the electric machine. Such cooling systems are disclosed, for example, in U.S. patent application Ser. Nos. 13/156,129 and 12/627,294 of Brad Chamberlin, et al., each incorporated herein by reference. Various embodiments may include cooling systems having baffles, nozzles, and the like for directing coolant spray to areas of particular concern, such as end turns of stator coils. A liquid gasket (not shown) or other suitable material may be applied to any exposed electrical surface of a terminal block portion to assure that liquid does not come into contact with an electrical circuit of the machine. A radiator (not shown) may be provided in the vehicle for cooling water or other coolant being circulated to remove heat from the electric machine and any associated equipment such as an inverter or other power dissipating devices.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A terminal block holder for securing a terminal block assembly having at least three conductive bus bars enclosed within corresponding individual insulating columns passing through a housing of an electric machine, the terminal block holder comprising:
a plate defining at least three openings therein; and
first and second dividers extending from the plate and respectively separating different adjacent ones of the openings,
wherein the plate is adapted to abut the terminal block assembly in a first direction, wherein the plate is adapted to abut the housing in a second direction, wherein the dividers are adapted to abut the terminal block assembly in a third direction, and wherein the first, second and third directions are substantially perpendicular to one another.

2. The terminal block holder according to claim 1, wherein the plate completely encloses the openings.

3. The terminal block holder according to claim 2, wherein the openings are circular.

4. The terminal block holder according to claim 1, wherein the plate partially encloses the openings.

5. The terminal block holder according to claim 4, wherein the openings are semi-circular.

6. The terminal block holder according to claim 4, wherein the dividers have flared portions formed for complementary abutment with flared portions of the terminal block assembly.

7. The terminal block holder according to claim 1, further comprising raised portions extending from the plate around each respective opening.

8. The terminal block holder according to claim 7, wherein the raised portions have a shape complementary to at least one of a fastener head, a ring terminal, and a washer.

9. The terminal block holder according to claim 1, formed of electrically non-conductive plastic.

10. An electrical termination system, comprising:
a housing of an electric machine having a plurality of individual passages connecting interior and exterior sides thereof;
a terminal block assembly having at least three conductive bus bars enclosed within corresponding individual insulating bodies passing through corresponding ones of the individual passages of the housing; and
a terminal block holder for securing the terminal block assembly, the terminal block holder comprising:
a plate defining at least three openings therein, each opening being aligned with a respective one of the bus bars; and
first and second dividers extending from the plate and respectively separating different adjacent ones of the openings;
wherein the plate abuts the terminal block assembly in a first direction, wherein the plate abuts one of the terminal block assembly and the housing in a second direction, wherein the dividers abut the terminal block assembly in a third direction, and wherein the first, second and third directions are substantially perpendicular to one another.

11. The system according to claim 10, wherein the plate completely encloses the openings.

12. The system according to claim 11, wherein the openings are circular.

13. The system according to claim 10, wherein the plate partially encloses the openings.

14. The system according to claim 13, wherein the openings are semi-circular.

15. The system according to claim 13, wherein the dividers have flared portions formed for complementary abutment with flared portions of the terminal block assembly.

16. The system according to claim 10, further comprising raised portions extending from the plate around each respective opening.

17. The system according to claim 16, wherein the raised portions have a shape complementary to at least one of a fastener head, a ring terminal, and a washer.

18. The system according to claim 10, formed of electrically non-conductive plastic.

19. The system according to claim 10, further comprising a sealing member disposed between the terminal block assembly and the exterior side of the housing for preventing contamination of the individual passages.

20. A method of securing a terminal block within a housing of an electric machine, comprising:
placing the terminal block assembly into abutment with the housing so that the terminal block assembly is positioned in close proximity to an exterior of the housing and extends through a plurality of individual passages to an interior of the housing; and
placing a terminal block holder into abutment with the terminal block assembly within the housing interior, so that the terminal block holder abuts the terminal block assembly in a first direction, abuts one of the terminal block assembly and the housing in a second direction, and abuts the terminal block assembly in a third direction,
wherein the first, second and third directions are substantially perpendicular to one another.
